(19) United States
(12) Patent Application Publication
(10) Pub. No.: US 2011/0025047 A1
(43) Pub. Date: Feb. 3, 2011

(54) End fitting for holding a high pressure capillary tube

(76) Inventors: Yury Zelechonok, Northbrook, IL (US); Vladislav Orlovsky, Wheeling, IL (US)

Correspondence Address: JOHN C SHEPARD, 575 SUNSET ROAD, WINNETKA, IL, 60093-4018, US

(21) Appl. No.: 12/462,309

(22) Filed: Aug. 3, 2009

(51) Int. Cl. F16L 5/00

(52) U.S. Cl. 285/212

(57) ABSTRACT

The disclosed fitting has a tubular body externally threaded at one end, to allow the fitting to be positioned over a capillary tube and connected to a cooperating component. The fitting has opposed gripping jaws at its other end suited for being flexed against the capillary tube for holding it relative to the fitting. A tubular nut fits over the gripping jaws, and cam faces provided between the nut and jaws serve to tighten or release the jaws relative to the tube, depending on which direction the nut is shifted axially along the body. The outside tubular face of the actuating member is knurled, providing for reliable manual gripping and axial shifting the actuating member.

### BACKGROUND OF THE INVENTION

High pressure liquid chromatography (HPLC) systems typically operate at pressures of 5,000 psi and higher. To withstand these pressures, capillary tubing is formed from an advanced polymer or a stainless steel. Further, end fittings are used to tightly grip, seal and connect the tubing relative to the system component.

More specifically, each end fitting typically has a tubular construction, with a through bore sized to receive the capillary tube. The forward end of the fitting typically has external threads for mechanically connecting the fitting into a cooperating threaded tap of a HPLC component. A separate or integrated tubular PEEK ferrule, is provided on the forward fitting end.

The fitting have a rearward radially enlarged region suited for finger gripping, allowing without any tools the needed fitting rotation with sufficient torque to tighten or loosen it relative to the HPLC component.

When the fitting is tightened into a cooperating HPLC component, the forward end ferrule is compressed between the fitting, capillary tube and HPLC component, creating a somewhat small annular region of pressurized ferrule that seals and mechanically clamps the tube and fitting together.

The forces between the ferrule and tube must be substantial in this region as they essentially form the only means axially holding the tube and fitting together. Thus, it is not uncommon to have clamping forces of the compressed ferrule that deform the underlying annular region of the tube.

Nonetheless, as this compressed annular ferrule/tube region is small, the generated axial holding force they provide frequently is inadequate at high pressure, whereby axial tube blowout from the fitting can occur, resulting in system failure.

### OBJECTS AND SUMMARY OF THE INVENTION

The primary object of this invention is to provide a fitting for holding and sealing a capillary tube relative to a cooperating component, such as an HPLC component, utilizing flexible finger-like grippers that can be biased against the tube with forces sufficient for firmly holding the tube relative to the fitting.

The improved fitting has a generally tubular body holding an end ferrule, the fitting body being sized to freely receive the capillary tube, with clamping finger-like grippers projected off the body and normally spaced from the capillary tube but capable if being flexed inwardly against the tube. A tubular actuator or nut positioned over the grippers is movable axially along the fitting. Cooperating cams between the nut and grippers operate upon relative axial nut/gripper movement in one direction to tighten the grippers against the tube for holding it in the fitting, and upon axial nut/fingers movement in the reverse direction to separate the grippers from the tube, allowing for tube removal, insertion or adjustment relative to the fitting.

This capillary tube gripping action is accomplished by this relatively quick and easy axial nut/fitting body movement, and sealing is accomplished by rotating both fitting components relative to the cooperating HPLC component.

### BRIEF DESCRIPTION OF THE SUBMITTED DRAWINGS

These and other objects, features and advantages of this invention will be fully appreciated after considering the following description and accompanying drawings, wherein:

FIG. 1 is a perspective view of the inventive fitting, showing a capillary tube positioned in the fitting body and with the fitting nut in the tube release position, for inserting, positioning or removing the tube relative to the fitting;

FIG. 2 is a perspective view of the fitting of FIG. 1, except with the fitting nut shifted to the tube clamping position;

FIG. 3 is a perspective view of a fitting nut;

FIG. 4 is a centered section view of the fitting nut;

FIG. 5 is a perspective view of a fitting body alone, without its cooperating fitting nut;

FIG. 6 is a section view as seen from line 6-6 in FIG. 7;

FIG. 7 is a centered section view of the fitting threaded into a cooperating component, with a capillary tube positioned in the fitting and with the nut in the release position;

FIG. 8 is a centered section view similar to FIG. 7, except showing the fitting holding and gripping the capillary tube; and

FIGS. 8a and 8b are enlarged views of the circled portions of the fitting and cooperating component of FIG. 8.

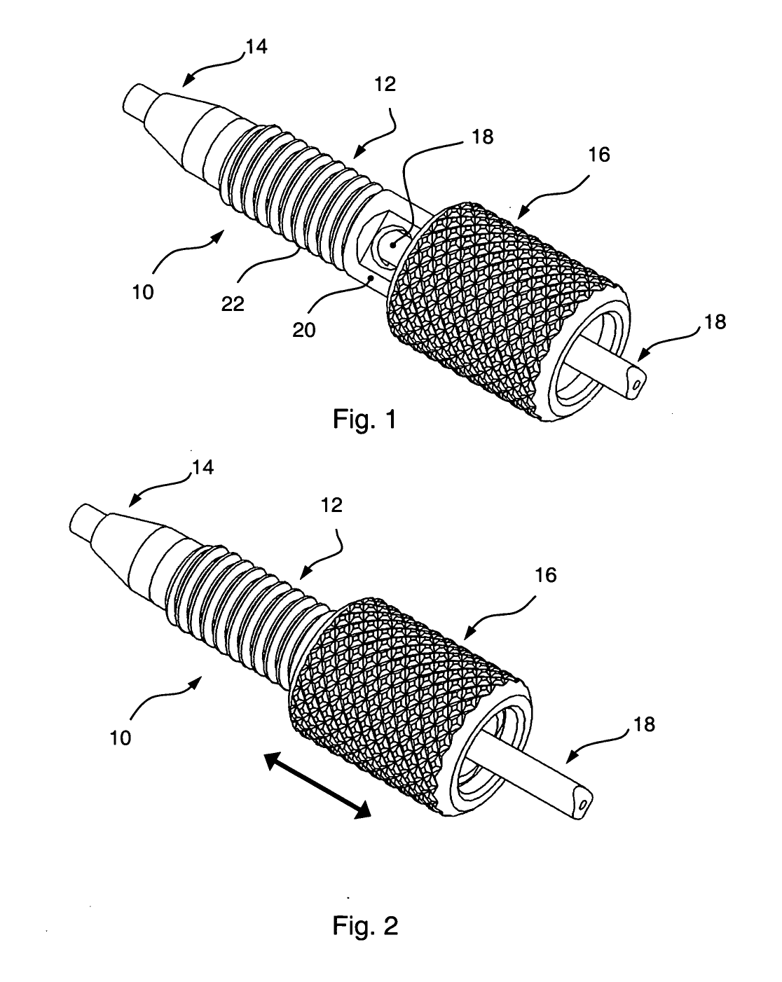

### DETAILED DESCRIPTION OF THE INVENTION

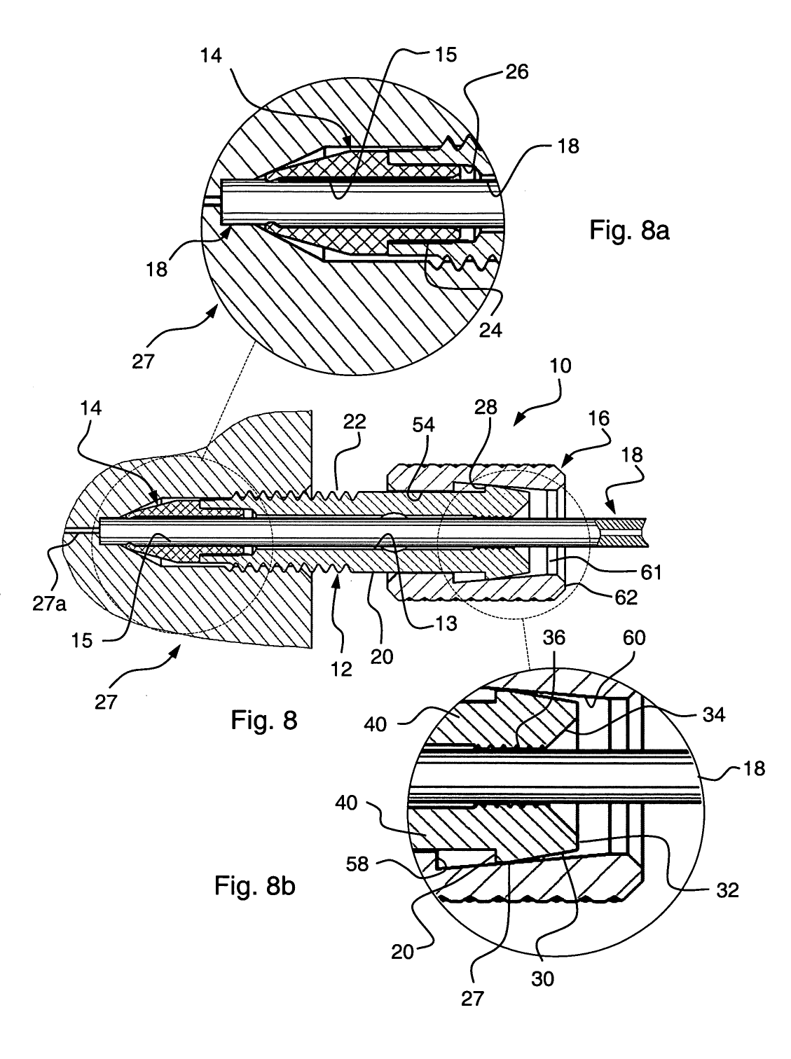

The inventive fitting 10 has three main components: an elongated body 12, an end ferrule 14 secured to the forward end of the body 12, and a nut 16 assembled onto the rearward end of the body. The fitting body 12 and end ferrule 14 are somewhat tubular, having aligned through bores 13 and 15 (FIGS. 5, 7 and 8) sized to have one end of a capillary tube 18 inserted through them. The fitting body 12 has a generally cylindrical medial exterior 20 and coaxial helical threads 22 located forwardly thereof. The smaller diameter end ferrule 14 is secured onto the body forward end, such as by ferrule boss 24 (FIGS. 8 and 8a) being press fit and held in a forwardly open body cavity 26. The fitting body threads 22 are connected to a cooperating threaded bore in the HPLC component 27, and the forward end of the tube 18 is projected beyond the ferrule 14 and sealed within or relative to the component bore 27a. The rearward end of the elongated body 12 is separated to define two generally symmetrical, opposing and coaxial rearwardly cantilevered fingers 28 (FIGS. 5, 6, 7 and 8).

Each finger 40 is wider than the tube 18, and has a forwardly facing shoulder 28 projected radially beyond the adjacent cylindrical exterior 20. An exterior conical face 30 (FIGS. 5 and 8b) converges rearwardly from shoulder 28 to a rear diametric end face 32. An interior conical face 34 diverges forwardly from the rear face 32, extending to the bore 13, and concentrically formed gripping teeth or abrasions 36 (FIGS. 5 and 8b) on the free ends of the fingers. The gripping teeth 36 are suited to overlie and hold the tube fitted through the bores 13 and 15.

The fingers, when flexed radially inward, thus will engage and stably hold the tube 18 between them. Otherwise, when the fitting fingers 40 are not inwardly flexed, the gripping teeth 36 are radially spaced from the capillary tube 18, allowing it to be freely inserted into or removed from the fitting bore 13.

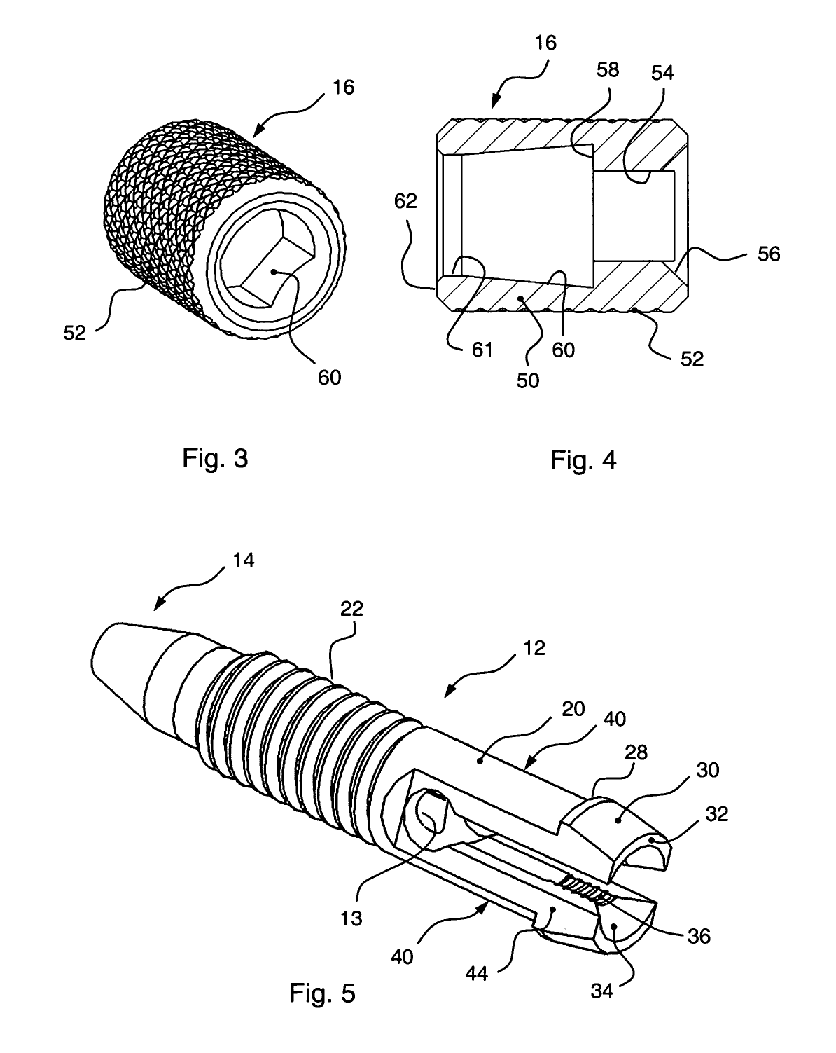

The nut 16 (FIGS. 3, 4, 6 and 7) is also tubular, having a generally cylindrical wall 50, with its exterior surface 52 knurled and its ends chamfered for easy finger gripping and ease of assembly onto the body 12. The nut double-D shaped through bore 54 is sized to slidably fit over the body portion 20, providing for a radial nut support on and movement axially along the body.

A conical cavity is located rearwardly of the bore 54, defined by an annular rearwardly facing radial shoulder 58 and a rearwardly converging conical cam face 60 that is extended between the shoulder and rear opening 61, the nut ending at rear face 62. This nut cavity is sized to receive the shoulders 28 and cam faces 34 of the body fingers.

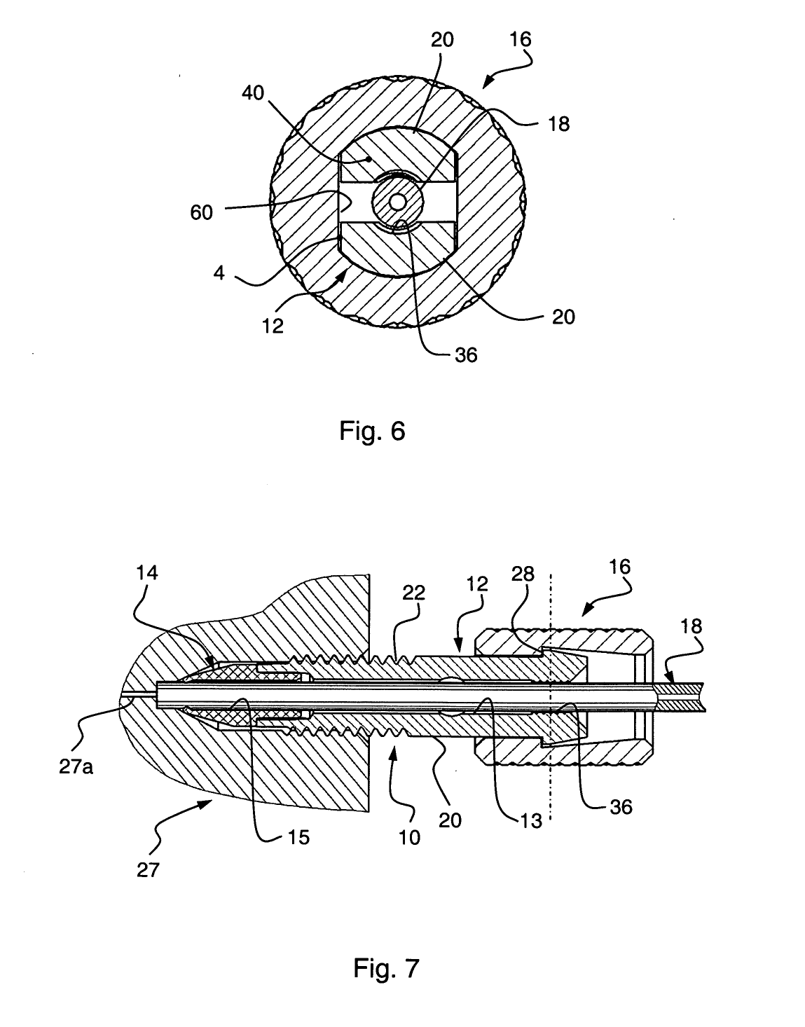

The nut can be freely shifted axially of the body. However, the nut will be rotatably keyed to the body via the opposed flat nut bore faces 60 (FIGS. 3 and 6) overlying the opposed body chordal faces 44.

With the fitting fingers unflexed and so positioned in the nut, the capillary tube 18 can be axially inserted through or removed from the body/ferrule bores 13/15.

The body fingers are normally spaced apart sufficiently to allow the capillary tube to be freely inserted into or removed from the body. Also, the nut cam face 60 is radially larger than the body shoulders at 38, so that when the nut is positioned on the body section 20 with the shoulder 38 abutting the nut face 57, the fingers are spaced from the tube. However, as the nut 16 is shifted axially forwardly along the body, the converging cam and nut faces will flex the body fingers inwardly, operable to tightly grip and hold the capillary tube as positioned therein.

The internal cam surface 58 of the actuating nut member might diverge between 1 and 15 degrees, providing that the underlying body surface 40 will create both a large gripping force of the fingers against the capillary tube as the nut is axially shifted forewardly along the body fingers, and the generated friction between the nut and body fingers will frictionally hold the nut as axially positioned.

When the nut is manually shifted in the reverse axial direction, or away from the cooperating HPLC component, the fingers will release gripping pressures against the tube, allowing for tube insertion or removal relative to the fitting. However, the fitting body and nut will remain assembled as a single or semi-unitary fitting unit.

What is claimed is:

1. A fitting for holding a tube relative to a cooperating component, comprising an elongated externally threaded tubular body adapted to fit over the tube and be threaded to the cooperating component, said body having gripping means normally spaced from the tube but suited to be shifted to contact and tightly hold said tube, finger operated actuating member carried on the body, and cooperating cam means on said actuating member and body operable upon axial actuating member/body movement in one relative direction to shift said gripping means tightly against the tube and operable upon axial actuating member/body movement in the opposite direction to release the gripping means from the tube.

2. A fitting according to claim 1, further including said one relative direction of axial actuating member-body movement is in the direction toward the cooperating component.

3. A fitting according to claim 1, further including an annular plastic ferrule fitted over the tube and into the tubular body operable to be confined between the tubular body and the cooperating component for producing an annular pressure tight seal between the tube and the cooperating component.

4. A fitting according to claim 1, further including said actuating member being tubular and having inside and outside faces, and the actuating member cam means being formed on said inside face.

5. A fitting according to claim 4, further including the outside face of the actuating member being knurled for allowing reliable manual gripping and axial shifting the actuating member.

6. A fitting according to claim 4, further including said cam means on the actuating member internal cavity being configured to diverge in the direction toward the cooperating component.

7. A fitting according to claim 1, further including said actuating member having an internal cavity in part defined by said cam means and extended radially beyond the threads of the body, and said threaded body having an enlarged portion positioned in the cavity and engaging said cam means, whereby axial actuating member shifting along the body causes said cam means to bias the gripping regions against the capillary tube for holding it.

8. A fitting according to claim 1, further including said the internal cam surfaces of the actuating member having a small diverging angle of the order between 1 and 15 degrees, operable to create both a large gripping force of the gripping regions against the capillary tube and to frictionally bind and hold the actuating member as positioned on the body cavity cam surfaces.

9. A fitting according to claim 8, further including said actuating member being tubular and having inside and outside tubular faces, the actuating member cam means being formed on said inside tubular face, and the outside tubular face of the actuating member being knurled for allowing reliable manual gripping and axial shifting the actuating member.

10. A fitting according to claim 8, further including said actuating member having an internal cavity in part defined by said cam means and extended radially beyond the threads of the body, and said threaded body having an enlarged portion positioned in the cavity and engaging said cam means, whereby axial shifting of the actuating member along the body causes said cam means to bias the gripping regions against the capillary tube for holding it.
